(19) United States
(12) Patent Application Publication
(10) Pub. No.: US 2005/0138381 A1
(43) Pub. Date: Jun. 23, 2005

(54) Dynamic content security processor system for XML documents

(76) Inventors: Thomas C. Stickle, St. James, NY (US); Dan B. Smiley, Framingham, MA (US); Javier S. Lopez, Cambridge, MA (US); Chad L. Cook, North Attleborough, MA (US); Michael C. Shaw, Needham, MA (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/909,741

(22) Filed: Aug. 2, 2004

Related U.S. Application Data
(60) Provisional application No. 60/492,069, filed on Aug. 1, 2003.

(51) Int. Cl. H04L 9/00; G06F 17/00

(52) U.S. Cl. 713/176; 715/513

(57) ABSTRACT

A dynamic content security parser (DCSP) that provides hardware assisted parallel processing technology for servicing complex web service security transactions at a high rate of throughput as an embeddable software product having a core DCSP engine that utilizes a content security policy to process documents in order to provide digital signature services, content encryption, XML filtering and SAML generation.

### CROSS-REFERENCE TO RELATED APPLICATIONS

This application claims priority to and incorporates by reference provisional patent application Ser. No. 60/492,069, filed Aug. 1, 2003.

### BACKGROUND OF THE INVENTION

1. Field Of the Invention

This invention relates generally to software methods for providing accelerated XML security operations for documents. More specifically, the invention is a system comprised of a dynamic content security parser (DCSP), comprised of a core processor engine, and a plurality of DCSP micro-engines, wherein the micro-engines are dedicated processors for providing added functionality such as filtering, document identification, XML digital signature generation, XML encryption, SAML generation, and SAML encryption, wherein the system enables a shift in the development of web services security towards policy programming, accelerates content security processing, and offers a flexible and embeddable software component for web services security.

2. Description of Related Art

The state of the art in XML document processing generally comprises a “Whole Document” approach, wherein an input XML document is parsed entirely and then loaded into memory. The next step is to search the parsed document for the portions of the input XML document that match a specific expression. The Whole Document approach is inefficient at best and unnecessary in most situations.

Accordingly, it would be an advantage over the prior art to provide a faster or optimized approach to analyzing and preparing an XML document for processing.

Current comprehensive security products are stand-alone solutions that are marketed as “best of breed” in their category. These products are selected by the consumer for their management capabilities, functional depth and breadth, as well as cost/performance advantage. However, the market fails to provide security products that can operate as embedded software components. The market also fails to provide security products in this class that are capable of operating on multiple reference platforms, or enable the user to continue to use a preferred application server, management infrastructure or development environment.

The market also provides products with support for web services security. Disadvantageously, these products are faced with severe performance challenges, and are not viable for scaleable web services applications.

Accordingly, it will be an advantage to provide scaleable and embedded software components that operate on multiple reference platforms, and provide performance gains in software that can be further amplified when ported to a hardware-assisted target reference platform.

### BRIEF SUMMARY OF THE INVENTION

It is an object of the present invention to provide accelerated content security through a dynamic content security parser engine and associated micro-function engines.

It is another object to provide accelerated content security for XML documents.

It is another object to provide web services security that is policy oriented.

It is another object to provide a high-level programming interface that will enable a programmer to create a content security policy that will simultaneously generate a digital signature and security assertion markup language (SAML) authentication assertion generation in a single pass.

In a preferred embodiment, the present invention is a dynamic content security parser (DCSP) that provides hardware assisted parallel processing technology for servicing complex web service security transactions at a high rate of throughput as an embeddable software product having a core DCSP engine that utilizes a content security policy to process documents in order to provide digital signature services, content encryption, XML filtering and SAML generation.

In a first aspect of the invention, scalability is provided through load balancing of requests across multiple micro-engines.

In a second aspect of the invention, performance is enhanced by pre-processing of XML documents for the micro-engines.

In a third aspect of the invention, efficiency is increased by providing policy-programming API where SAML and digital signature (DSIG) are requested at the same time.

In a fourth aspect of the invention, manageability is provided in a secure management interface.

In a fifth aspect of the invention, a single development environment enables developers to avoid stitching together of multiple libraries to creates SIGS, SAML, VALIDATION, ENCRYPTION and FILTERING rules.

In a sixth aspect of the invention, developers are able to apply multiple policies using a policy-programming approach using an abstract XMLSec API.

In a seventh aspect of the invention, content security is accelerated using parallel processing technology of the DSCP engine.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram that illustrates the relationship between the present invention, the developer, and reference platforms.

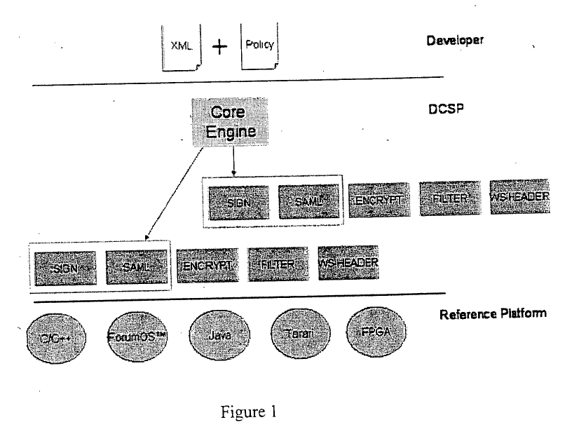

FIG. 2 is a block diagram of the DCSP system architecture.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

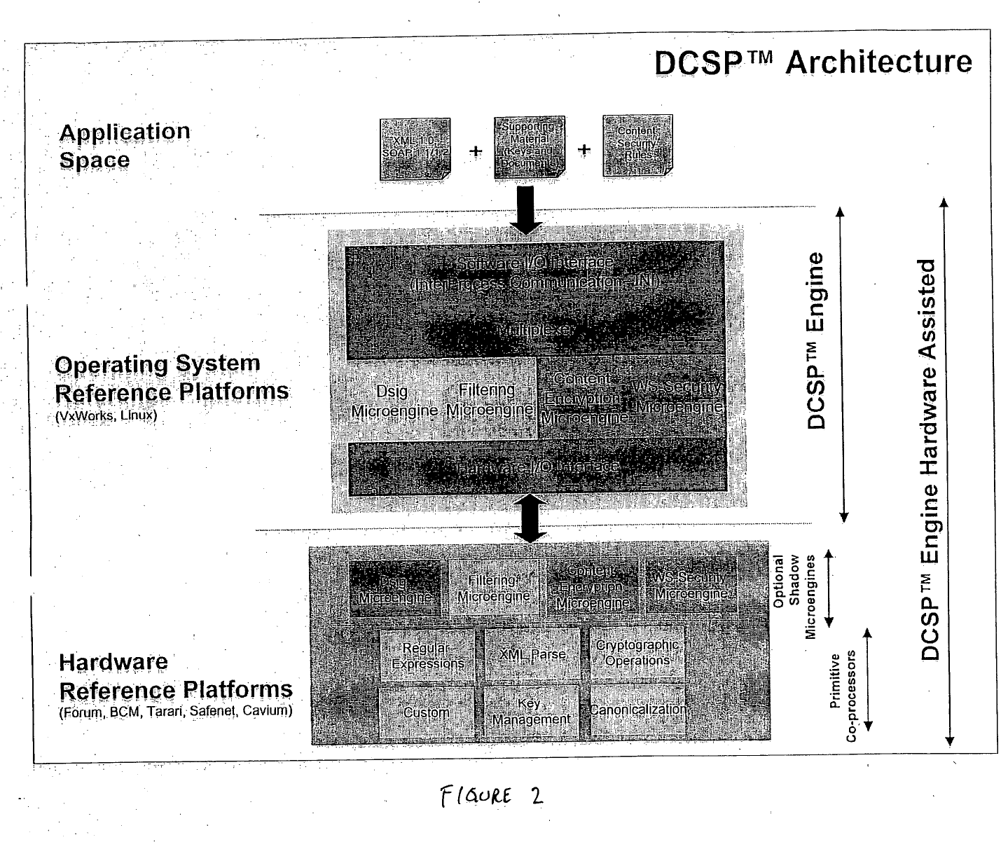

The presently preferred embodiment of the invention is illustrated in FIG. 2. FIG. 2 is a block diagram that illustrates the dynamic content security parser (DCSP) architecture and its relationship to documents to be processed. Beginning with input, the DCSP engine 10 accepts documents 12, supporting material 14, and content security rules 16. The DCSP engine 10 operates on an Operating System (OS) reference platform such as VxWorks or Linux. The input material 12, 14, 16 are received at a software Input/Output Interface 18.

A DCSP core engine receives the input and provides various functions. First, the DCSP core engine provides a secure software I/O interface exposed via Inter-process communication, JNI or loctl. Next, the DCSP core engine includes a secure communications interface to any number of micro-engines. Likewise, the DCSP core engine includes a secure execution environment for micro-engines that perform the optimized functions of the DCSP engine 10. Furthermore, the DCSP core engine manages the execution of a policy on an appropriate micro-engine while performing load balancing across all of the available micro-engines. The DCSP core engine also provides a pre-processing environment for configuration files as well as the XML documents being processed. Pre-processing includes determining which instructions within a configuration file can be executed and on which micro-engines, and then submitting the appropriate inputs to the appropriate micro-engine from the configuration files. Finally, the DCSP core engine provides a management and monitoring interface for control of the DSCP engine.

It is envisioned that at least four micro-engines will provide the desired functions of the DSCP system 10, but more micro-engines can be added as increased functionality or throughput is required. The important aspects of the DCSP engine 10 are that it has a layered, extensible and modularized architecture in order to provide a safe, distributed and scalable computing model for content-security policies.

Micro-engines are designed to execute well-defined content-security operations in an efficient manner. Speed and efficiency are obtained because they receive pre-processed documents and configuration files from the DCSP core engine.

It is envisioned that four micro-engines would be released with the first product to be shipped. The four micro-engines will execute four optimized content security operations. The first operation is applying a digital signature. This could be, for example, a WS-Security Digital Signature, or an XML Digital Signature. The second operation is content encryption of the document. The micro-engine would thus perform both optimized encryption and decryption. The third process is XML filtering. Such filtering would be performed on SOAP 1.1/1.2, XML 1.0, XSD, DTD, and WSDL based filtering. The fourth operation relates to WS Security in the form of SAML generation and consumption.

Interaction between the micro-engines and the DCSP core engine are important for the benefits of the present invention to be achieved. For example, if a policy requires execution of a Digital Signature and a SAML assertion, then the DCSP core engine would control what information was sent to each micro-engine, and then how the micro-engines would interact in order to perform their functions in the most efficient manner possible, operating in parallel whenever possible. The DCSP core engine would also pre-process the document before transmission to the micro-engines.

It is observed that the desired benefits of a policy driven DCSP system as described changes the approach to the problem of document processing. Instead of being concerned with how a document is to be processed, the issue becomes what should be processed. Thus, the application developer moves way from a procedural approach, and moves to specifying what data transformations should occur, rather than how each transformation should be performed.

It is also noted that the present invention encapsulates and abstracts the myriad of possible WS-Security variables and options in a simple XML syntax and enables the construction of all of the various message objects and the setting of values for the object attributes.

As part of the present invention a content security policy configuration (CSPC) XML schema encapsulates all of the possible rules in order to set the run-time environment, execution variables, and then instruct the DCSP system to perform its functions.

An example of a digital signature CSCP file might include: a document (parsed or events), node to sign (XPATH), private key location or reference, and digital signature type (enveloped, WS-Security etc.)

It is noted that the WS-POLICY specification already defines in XML how to represent WS-Security security rules in a standard format. Because the GUI Workbench already writes a similar file, the present invention will extend the XML format to become a pseudo WS-POLICY configuration file that drives the programming of the DCSP system.

An important aspect of the present invention is to ensure that the DCSP system readily supports multiple reference software platforms, including C/C++, Java, Sentry, FPGA on a PCI, Tarari, etc. The DCSP system should also be sufficiently small such that it can be readily ported to client-side environments. Such ability means that a user interface would also be required.

It is envisioned that the DCSP core engine and micro-engines would initially offer performance gains in software alone. However, specific code paths within the DCSP system, or the entire DCSP system could be implemented in hardware in order to accelerate functions.

The present invention also includes other options and improvements. For example, after the DCSP core engine and micro-engines have completed their functions, the results are transmitted via a hardware I/O interface to the hardware platform for use. However, these uses include further processing by optional shadow micro-engines. Other options include processing by primitive co-processors. These co-processors would add the features of performing regular expressions, XML parse, cryptographic operations, custom operations, key management, and canonicalization. Note that the DCSP core engine, micro-engines, optional shade micro-engines, and primitive co-processors can all be supplemented through hardware.

It should be understood that while the ultimate goal is to increase the throughput of document processing in XML web services security, this goal will be realized by the ability to the present invention to perform dynamic one-pass processing. One-pass processing means that a document is traversed once in order to perform a specific content processing operation, rather than repeatedly traversing the document for each step of parsing, processing, and serializing. The prior art teaches traversing XML documents multiple times to first build an initial DOM model, then traversing and manipulating the DOM model for digital signatures, and ten traversing and manipulating the DOM model to serialize the DOM back to XML format. One-pass processing eliminates DOM construction and traversal in order to integrate signing and other document processing steps into the parsing phase, eliminating the need for a second traversal. One-pass processing can also output an XML document directly from the parser, eliminating third-pass serialization.

Accordingly, the present invention combines XML parsing and security content processing to thereby perform a digital signature operation while the document is read the first time.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

1. A method for providing accelerated XML security operations for documents, said method comprising the steps of:
1) providing a dynamic content security parser (DCSP) wherein the DCSP is comprised of a core processor engine, and a plurality of DCSP micro-engines; and
2) processing documents by applying the functionality of the DCSP micro-engines to thereby perform document filtering, document identification, XML digital signature generation, XML encryption, SAML generation, and SAML encryption.

2. A dynamic content security parser (DCSP) system for providing accelerated XML security operations for documents, said system comprised of:
a core processor engine; and
a plurality of DCSP micro-engines, wherein the plurality of DCSP micro-engines perform document filtering, document identification, XML digital signature generation, XML encryption, SAML generation, and SAML encryption.
